(19) United States
(12) Patent Application Publication
(10) Pub. No.: US 2002/0192338 A1
(43) Pub. Date: Dec. 19, 2002

(54) Portable food container having separate compartments

(76) Inventors: Richard B. Ness, Apple Valley, MN (US); Daniel M. Sutherland, Arden Hills, MN (US); Robert C. Freed, North Oaks, MN (US)

Correspondence Address: Beck & Tysver, P.L.L.C., Suite 100, 2900 Thomas Avenue S., Minneapolis, MN, 55416, US

(21) Appl. No.: 10/055,056

(22) Filed: Jan. 22, 2002

Related U.S. Application Data
(60) Provisional application No. 60/263,325, filed on Jan. 22, 2001.

(51) Int. Cl. A23B 4/00

(52) U.S. Cl. 426/119

(57) ABSTRACT

A portable food container 2 for separately retaining first and second food items. The preferred portable food container 2 includes an outer container 10 including a first receptacle 12 at least partially defining a first compartment 13, an inner container 20 including a second receptacle 22 at least partially defining a second compartment 28, and an upper cover 50. The first receptacle 12 has an outer rim 16 and a first receptacle opening 18 defined by the outer rim 16. The second receptacle 22 has a peripheral collar 30 having an outer edge 34 and an inner edge 34, the outer edge 32 designed and constructed to engage the outer rim 16 of the first receptacle 22 such that the inner container 20 resides at least partially within the outer container 10. The inner edge 34 defines a second receptacle opening 36 and the peripheral collar 30 has an upper surface 38 interconnecting the outer edge 32 with the inner edge 34. The upper surface 38 has an upper surface opening 40, which communicates with the first compartment 13 when the outer edge 32 of the inner container 20 is engaged with the outer rim 16 of the outer container 10. The upper cover 50 is designed and constructed to engage the peripheral collar 30 in such a manner so as to retain a first or second food items placed within the second compartment 28 when the upper cover 50 is engaged with the peripheral collar 30 and the second receptacle 22 is turned upside down. In preferred embodiments, the volume of the second compartment 28 is preferably from about 50% to about 99% of the total volume of the first and second compartments 13, 28 combined. In further embodiments, a further preferred portable food container 2′ preferably has a flavor tablet 61 including flavoring agents; wherein the flavor tablet 61 dissolves, thereby releasing the flavoring agents, when the tablet 61 comes into contact with fluids within the first compartment 28 having an aqueous phase. In yet other embodiments, the second receptacle opening 36 is preferably separated from the upper surface opening 40′ by a distance of less than about 1 inch and the peripheral collar 30′ preferably includes an air vent opening 64.

### FIELD OF THE INVENTION

The present invention relates generally to a portable, serving size food container having separate compartments for separate food items. The present invention provides a novel packaging system for storage, transport and simultaneous consumption of the separate food items in a manner, which provides satisfaction to the consumer. The packaging system is designed to be disposable and provides a cost effective system for enabling consumers to “grab a bite of food” while rushing from place to place in rapid-paced lifestyles.

### BACKGROUND OF THE INVENTION

It is well known to provide containers for food items of all sorts. Shelf life is always a parameter in considering the design and construction of packaging for food. Containers for fluid food items such as milk, coffee, fruit juice, carbonated beverages and water have certain characteristics depending upon the intended storage period and mode of consumption. When the intended storage period is relatively short, a paper cup will often do. On the other hand, when it is also desirable to provide a solid food item or a dried food item that is commonly consumed in combination with such a fluid food item, these separate food items are generally packaged separately and consumed either serially, or in certain instances, following mixing, as is generally the case with dried food items such as breakfast cereals. American consumers are particularly interested in consuming breakfast cereals with milk, which, when mixed together have become one of the most healthful constants in breakfast food. However, if the cereal sits in the milk too long, the cereal begins to soften and becomes less desirable to most consumers who appreciate the crispness of the dry cereal when mixed with milk. Obviously, for that reason, dry cereal cannot be packaged directly with milk.

In today's fast-paced world, however, consumers would like to take their breakfast cereal away from the confines of the kitchen table and enjoy it in the den, in the bedroom, on the porch, in their car, on an airplane, on a bus, on a train, on a subway, in a boat, in a golf cart, at their desks, at a ballgame, at a picnic, on their way to class, in class, etc., without fear of the spillage inherent with the traditional bowl and spoon. There is presently no adequate way of doing this.

Breakfast cereals have been packaged in single serving size packages, such as in relatively small boxes which could be conveniently taken with the family on an outing. The cereal could always be eaten dry in the back seat of the car, but mixing the cereal with milk in the back seat, or the front seat for that matter, would be problematic at best. One could mix the cereal at home and then take it “out the door”, however, there remains a strong possibility that the combination will be spilled in the car, creating a mess in the car. Today, serving size packages are made in the form of a small bowl with a foil covering which is removed prior to use. Such packaging, however, does not provide an adequate system for taking the cereal into the car and commuting to the kids' games, to school or to work. Further, such packaging does not provide compartments for containing both milk and cereal separate from one another and for subsequently dispensing a combination of milk and cereal.

It will be appreciated, therefore, that there is a need for a portable food packaging system, with convenient single hand operability, which allows consumers to enjoy a combination of foods such as breakfast cereal and milk, or other dry or solid foods in combination with other fluid foods, anytime, anywhere.

It will also be appreciated that, in order to provide such a food packaging system in a cost effective manner, it would be desirable to provide such packaging in an inexpensive and preferable disposable packaging system.

It will be appreciated, therefore, that improvements over the presently available portable food packaging systems, which could improve the convenience of such packaging systems and also minimize the cost of the same, would be a welcomed contribution to food packaging and consumer convenience, and that prior art portable food packaging systems present problems which are in need of solution. The present invention provides solutions for these and other problems.

### SUMMARY OF THE INVENTION

In accordance with the present invention, a portable food container is provided which is designed to facilitate “on the go” consumer use. The food container provides two separate, nested compartments which can be employed such that each compartment contains a different food item. A cover coordinates with each compartment such that each compartment is sealed from the other and from the environment. The cover, in coordination with openings defined in the compartments, further provides the user the ability to selectively open one or both compartments to the environment, and to dispense the contents of either compartment or of both compartments serially or simultaneously.

The present portable food container is designed for the storage, transport, and simultaneous consumption of popular solid or dry foods in combination with liquid foods with which these foods are commonly consumed, although the present container may also be suitable for other applications as well. The present container stores the solid or dry foods and liquid foods in separate compartments for freshness, and essentially provides an inner container within an outer container, thereby providing separate compartments for each of the respective food items. The solid and liquid food items are then delivered from the combination device as desired by the consumer, either independently or simultaneously. The present invention preferably provides a portable food container for separately retaining first and second food items, the portable food container including an outer container including a first, the first receptacle having an outer rim and a first receptacle opening defined by the outer rim; an inner container including a second receptacle at least partially defining a second compartment, the second receptacle having a peripheral collar having an outer edge and an inner edge, the outer edge designed and constructed to engage the outer rim of the first receptacle such that the inner container resides at least partially within the outer container; the inner edge defining a second receptacle opening; the peripheral collar having an upper surface interconnecting the outer edge with the inner edge; the upper surface having an upper surface opening which communicates with the first compartment when the outer edge of the inner container is engaged with the outer rim of the outer container; and an upper cover designed and constructed to engage the peripheral collar in such a manner so as to retain a first or second food item placed within the second compartment when the upper cover is engaged with the peripheral collar and the second receptacle is turned upside down. In preferred embodiments, the volume of the second compartment is from about 50% to about 99% of the total volume of the first and second compartments combined. In further embodiments, preferred portable food container has a continuous adhesive seal joining the peripheral collar to the outer rim of the outer container and the outer rim preferably has an annular perimeter. In yet other embodiments, where the second receptacle has an outer wall which at least partially defines the first compartment when the outer edge of the peripheral collar is engaged with the outer rim of the outer container, the portable food container preferably has a flavor tablet including flavoring agents; wherein the flavor tablet dissolves, thereby releasing the flavoring agents, when the tablet comes into contact with fluids within the first compartment having an aqueous phase. In yet other embodiments, the second receptacle opening is preferably separated from the upper surface opening by a distance of less than about 1 inch and the peripheral collar preferably includes an air vent opening.

The present portable food container offers the consumer a system which allows the consumer to simultaneously consume two different food items, preferably a liquid food item and a solid or dry food item in a convenient, single-hand operation. The solid and liquid contents contained in the separate compartments are easily extracted using either (1) by employing gravity, by simply inverting the portable container from a stationary, upright position, and/or employing a slight squeeze to add a pressure to the outer walls of the preferably flexible outer container to increase flow of the liquid contents, and/or employing a slight suction over the upper surface opening to increase flow of the liquid contents; or (2) by using motion to create momentum which allow the inertia of the solid or dry food items to come out of the second compartment after the cover is removed.

The present portable food container offers the ultimate in convenience and choice for the on-the-go consumer. For the first time, consumers can enjoy their favorite combination snack and drink anytime, anywhere, all from one, easy-to-use container. The present invention is great for today's consumers who are under constant time pressure and the need to commute from place to place when time is limited between various scheduled events requiring attendance.

It will be appreciated that when drinking from the first compartment, the mouth of the user may seal against the upper surface adjacent the upper surface opening to prevent spillage of fluid food items contained in the first compartment. The consumer can separately cover the upper surface opening with their tongue and allow solid or dry food items in the second compartment to fall into the consumer's mouth and then remove his or her tongue from the upper surface opening, and then draw fluid from the first compartment. Accordingly, it is a general object of the present invention to provide a portable food container, which enables a user to drink from the first compartment through an opening in the upper surface comfortably and without spillage and then shake or pour a solid or dry food item from the second compartment into his or her mouth. These steps can be ordered in any manner deemed to be suitable to the consumer, depending upon the desire the consumer has at any particular time.

It is an additional object of the present invention to provide a relatively inexpensive portable food container for carry-out combination foods that are generally not mixed prior to consumption generally to improve shelf stability of the respective food items, particularly the crispness of dry or solid food items which might otherwise diminish when standing mixed with a fluid food items over even relatively short periods of time.

It is an additional object of the present invention to provide a portable food container which is configured so that a plurality of inner containers and also a plurality of outer containers may be stacked or nested for convenient and compact storage prior to use.

Further object and features of the present invention will become apparent from the following description and the accompanying drawings.

These and various other advantages of novelty that characterize the present invention are pointed out with particularity in the claims and appended hereto and forming a part hereof. For better understanding of the present invention, however, its advantages and other objects attained by its use, reference should be made to the drawings, which form a further part hereof, and to the accompanying descriptive matter, in which there is illustrated and described preferred embodiments of the present invention.

### BRIEF DESCRIPTION OF THE DRAWINGS

The present invention will be described in connection with the accompanying drawings, in which the reference numerals refer to the same or similar parts of the respective embodiments:

FIG. 1 is a perspective view of a preferred portable food container 2 in accordance with the present invention;

FIG. 2 is an exploded perspective view of the preferred portable food container 2 shown in FIG. 1;

FIG. 3 is a cross-sectional view of a further preferred portable food container 2′ similar to that shown in FIG. 1 as it would be seen from the line 3-3, but that differs slightly in that this embodiment shows (1) a continuous adhesive ring 48 sealing the peripheral collar 30′ of the inner container 20′ to the outer rim 16′ of the outer container 10′; (2) a fluid food item 44 within the first compartment 13′ and a dry food item 46 in the second compartment 28′; and (3) a flavor tablet accepting recess 62 on the bottom 63 of the inner container 20′;

FIG. 4 is an enlarged cross-sectional view of a portion of the preferred portable food container 2′ shown within the encircle portion of FIG. 3;

FIG. 5 is a perspective view of the top side 55′ of an alternate cover 50′ of an alternate portable food container in accordance with the present invention;

FIG. 6 is a perspective view of the bottom side 54′ of the alternate cover 50′ shown in FIG. 5;

FIG. 7 is an exploded side view of the alternate portable food container 2 similar to that shown in FIG. 1, but showing the alternate cover 50′ shown in FIGS. 5 and 6;

FIG. 8 is an exploded bottom perspective view of the alternate inner container 20′, which differs slightly from the inner container of the preferred portable food container shown in FIG. 3 in that the bottom 63 of the second receptacle 22′ has been modified to include a flavor tablet 61 which is separated from the tablet accepting recess 62 when shown in the exploded view;

FIG. 9 is an enlarged cross-sectional view, similar to the view shown in FIG. 3, but of a portion of the alternate inner container 20′ shown in FIG. 8, showing the flavor tablet 61 within the tablet accepting recess 62;

FIG. 10 is a top plan view of the top side of the alternate portable food container 2′ shown in FIG. 7, but showing a portion of the alternate cover 50′ removed to permit a user to drink from the upper surface opening 40′;

FIG. 11 is a top plan view of the top side of the alternate portable food container 2′ shown in FIG. 7, but showing a portion of the alternate cover 50′ removed to permit a user to drink from the upper surface opening 40′ and accept dry breakfast cereal from the second compartment 28′;

FIG. 12 is a top plan view of the topside of the alternate cover 50″ for an alternate portable food container 2′ similar to that shown in FIG. 7, but showing an alternate solid food item in the second compartment 28′, the alternate cover 50′ permitting visual observation of the solid or dry food item and allowing air to pass in and out of the second compartment 28′ via air holes 80 in the alternate cover 50″;

FIG. 13 is a top plan view of the topside of an alternate portable food container similar to that shown in FIGS. 1 and 2, but showing two alternate covers, a second compartment cover 50a′″, which is force fit into the second receptacle opening 36′ in a manner similar to the cover 50 shown in shown in FIGS. 1-4, and an upper surface adhesive cover 50b′″ having an adhesive 52′″ on a portion of the underside of the flexible cover 50b′″;

FIG. 14 is a top plan view of the topside 55″″ of an alternate cover 50″″ similar to the cover 50′ shown in FIGS. 5-7 and showing the inner container 20 in phantom, the alternate cover 50″″ being an adhesive type cover similar to that shown in FIGS. 5-7, but also including an adhesive patch 66 on the top side 55″″ of the alternate cover 50″″, which adhesive patch 66 is covered with an adhesive protector 68 which can be easily peeled off to expose the adhesive patch 66;

FIG. 15 is a side view of the alternate cover 50″″ shown in FIG. 14, but showing the inner container 20 shown in FIG. 7 in phantom and a portion of the cover 50″″ folded back on itself so that the adhesive patch 66 on the top side 55″″ of the alternate cover 50″″ will serve to secure the portion of the cover, folded back on itself, in order to expose and open the upper surface opening (not shown); and

FIG. 16 is a side view of the alternate cover 50″″ shown in FIG. 14, but showing the cover 50″″ folded back on itself, albeit in a different place than previously shown in FIG. 15, in order to expose and open the upper surface opening (not shown) and a portion of the second receptacle opening (not shown).

### DETAILED DESCRIPTION OF THE PREFERRED EMBODIMENTS

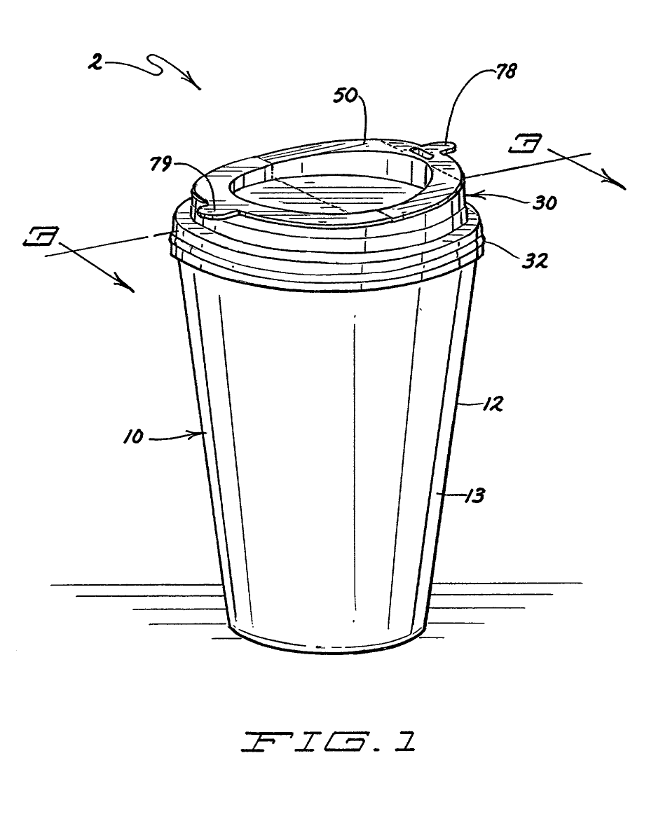

Referring now to the Drawings and specifically to FIGS. 1-2, the present portable food container 2 includes an outer container 10 and an inner container 20. In preferred embodiments, the portable food container 2 includes a cover 50. The outer container 10 provides a first receptacle 12, which at least partially defines a first compartment 13. The outer container 10 preferably includes an outer rim 16, which defines a first receptacle opening 18. The inner container 20 provides a second receptacle 22 having an outer wall 24 and an inner wall 26, the inner wall 26 at least partially defining a second compartment 28. The inner container 20 further providing a peripheral collar 30 having a rim grasping outer edge 32, which is designed to easily force fit over the outer rim 16 to enable the inner container 20 to engage the outer container 10. The peripheral collar 30 also includes an inner edge 34 interconnecting the peripheral collar 30 with the inner wall 26 of the second receptacle 22. In addition, the peripheral collar 30 of the preferred embodiment, shown in FIGS. 1-2, includes an upper surface 38, which interconnects the inner edge 34 with the outer edge 32. The inner edge 34 defines a second receptacle opening 36 communicating with the second compartment 28. The upper surface 38 preferably includes an upper surface opening 40, which communicates with the first compartment 13 when the outer edge 32 of the peripheral edge 30 is engaged with the outer rim 16 of the outer container 10.

In the preferred embodiment shown in FIG. 1, the outer container has a fill line 60. In a preferred embodiment the outer container 10 is of a translucent material and this characteristic, in conjunction with the fill line 60, aids the user in placing an appropriate amount of a fluid food item into the first receptacle if the first receptacle is to be filled by the consumer. The outer container 10 further includes an air vent opening or vent hole 64 to allow fluid food items such as milk, coffee or any of the newer fruit or fruit/milk combination beverages to flow easily out of the first receptacle when the portable food container is partially inverted by the consumer.

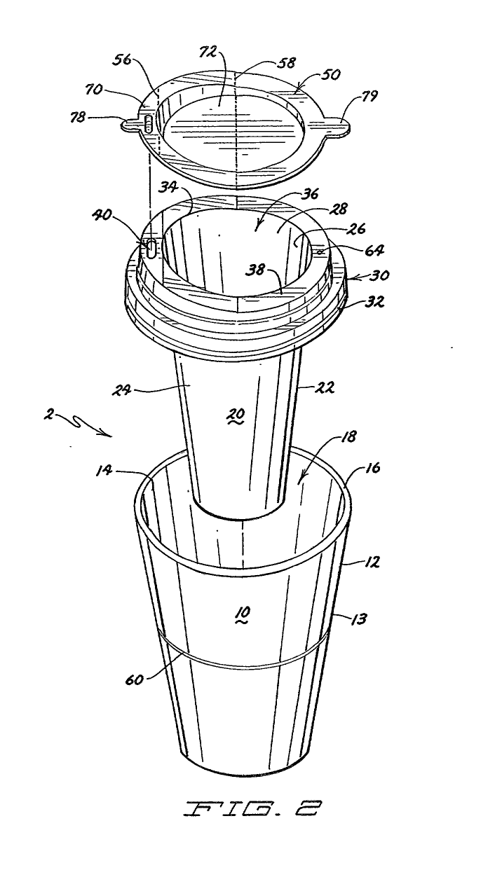

Referring now also to FIGS. 3-4, a further preferred embodiment of the portable food container 2′ is shown with the same cover 50 as illustrated in FIGS. 1 and 2. The preferred cover 50 is generally lightly force fit into both the upper surface opening 40, 40′ and the second receptacle opening 36, 36′ so that these openings are closed and that food items, i.e. a fluid food item 44, such as that shown in the first compartment 13′, in the preferred embodiment shown in FIG. 4, and a solid or dry food item 46, such as that shown in the second compartment 28′, in the preferred embodiment shown in FIG. 4., are retained within the portable food container 2′ when the portable food container 2′ is inverted from the upright position shown in FIG. 3.

In the preferred embodiment shown in FIGS. 3 and 4 the peripheral collar 30′ is sealed to the outer rim 16′ by a continuous adhesive ring 48 designed and constructed to prevent the inner container 20′ from being separated from the outer container 10′. In one preferred embodiment of the present invention, the fluid food item 44 within the first compartment 13′ is preferably milk and the solid or dry food item 46 in the second compartment 28′ is preferably a dry cereal such as wheat flakes or the like. It will be appreciated that the respective fluid food item and the respective solid or dry food item placed in either of the respective first and second compartments are any of the many fluid and/or solid or dry food items that are known in the art, and that the appropriate combinations of these food items will be any combinations of the same which are known to be desired combinations of foods or are subsequently determined to be desirous combinations of foods. For example, the food items in both compartments may be solids, or both may be semi-solid or semi-liquid, or both may be liquid. Thus the present invention provides a system for delivery of food combinations in a ready-to-eat, easy-to-manage package that is readily disposable and readily portable.

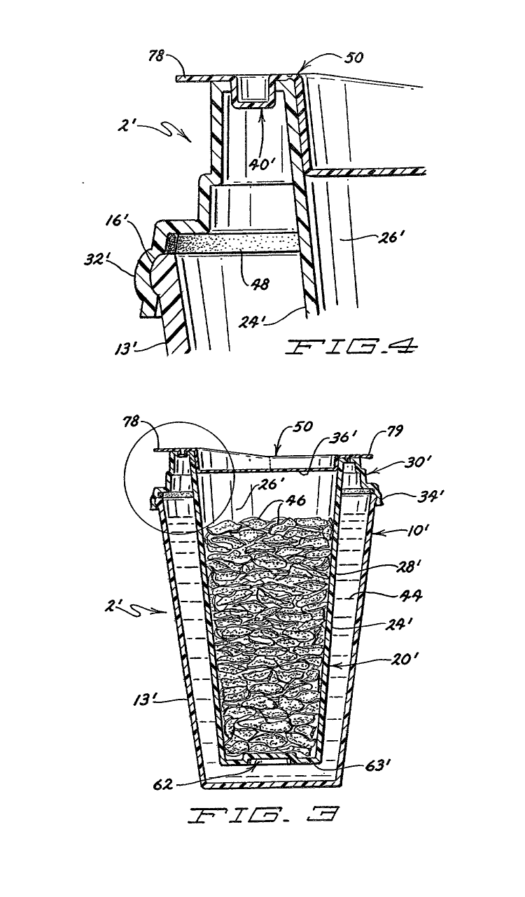

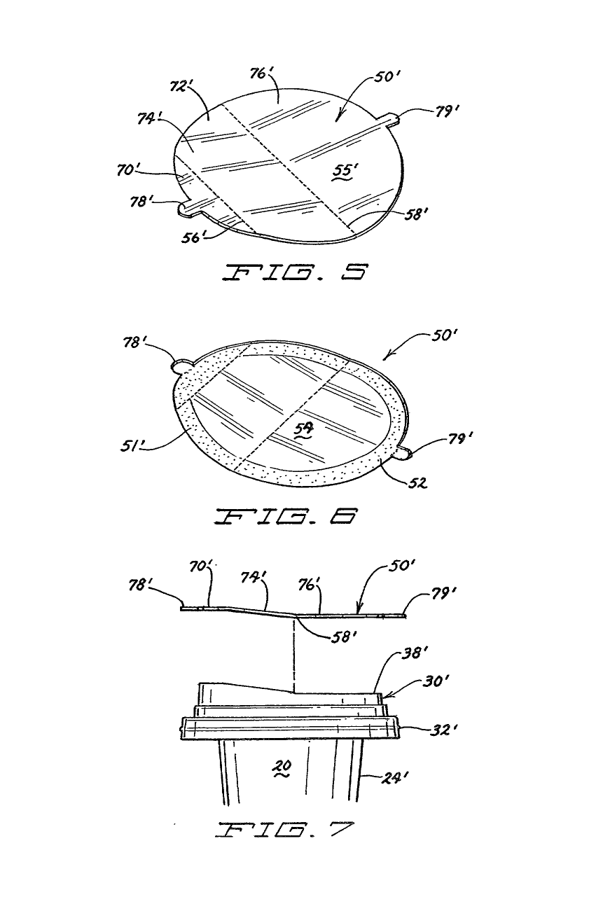

Referring now also to FIGS. 5-7, an alternate cover 50′ is shown. The alternate cover 50′ is a one-piece cover having an adhesive 52′ on the underside 54′ of the cover 50′. The adhesive 52′ acts to secure the cover 50′ to the peripheral collar 30 and to close the upper surface opening 40′ and the second receptacle opening 36′. The preferred adhesive 52′ is one that is approved for use on food packaging that will come into contact with the consumer's mouth and may in fact be ingested in small amounts.

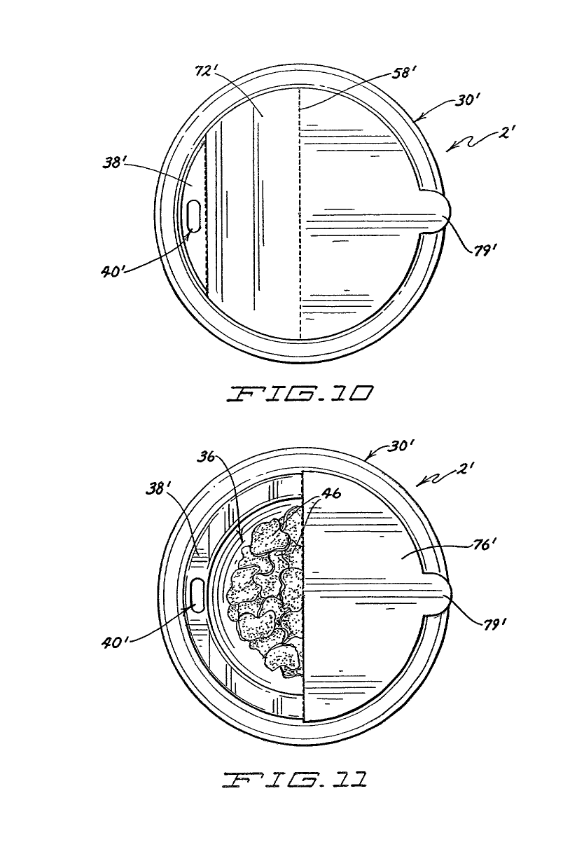

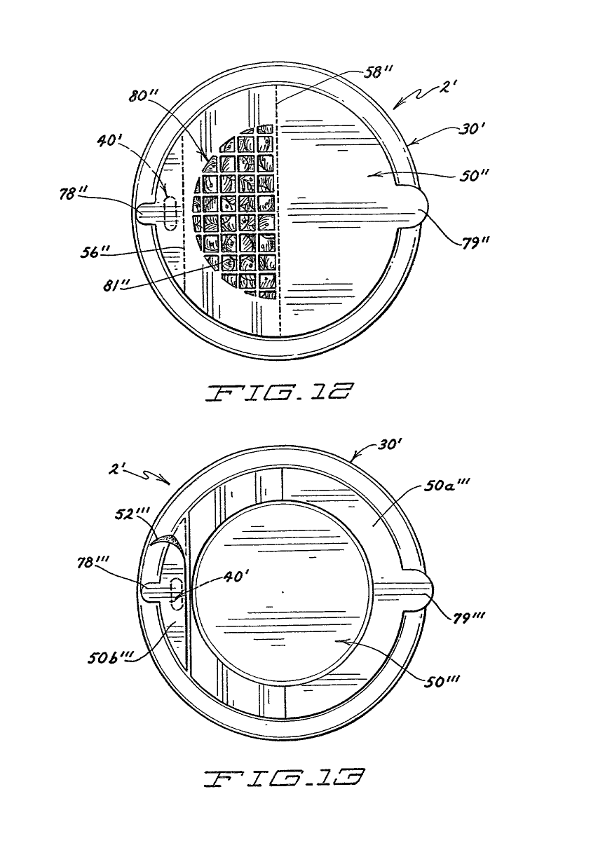

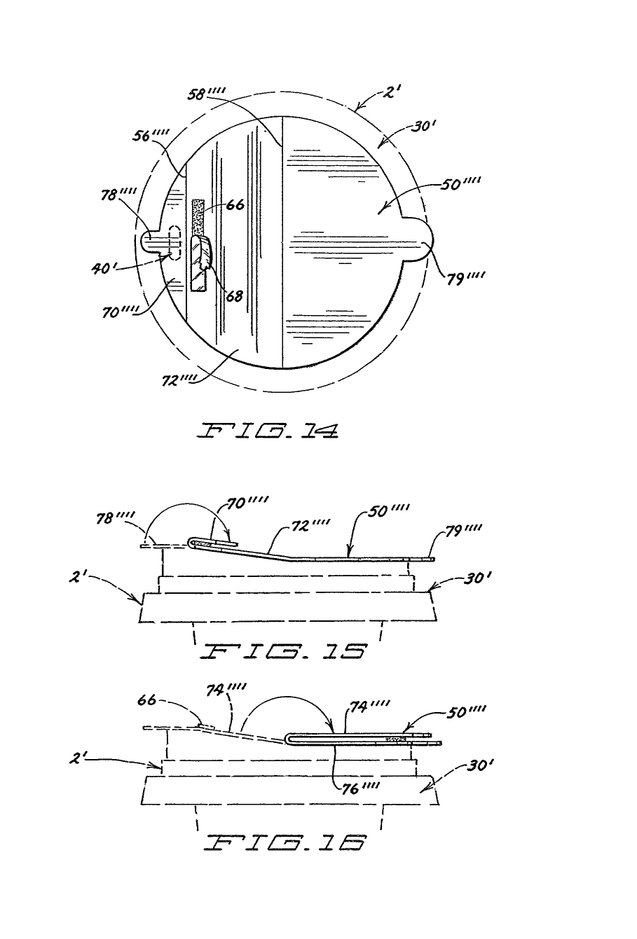

The cover 50 illustrated in FIGS. 1 and 2, the cover 50′ illustrated in FIGS. 5-7, the cover 50″ of FIG. 12, the cover 50′″ of FIG. 13, and the cover 50″″ of FIGS. 14-16 each include areas of reduced strength (e.g. fold lines or perforated lines) which enable the cover 50, 50′, 50″, 50′″, 50″″ or portions of the cover 50, 50′, 50″, 50′″, 50″″ to be folded out of the way selectively or to be selectively torn away, to allow the interior of the first and second compartments to communicate with the environment via openings 40, 40′, 36, 36′, 66. This will now be described in greater detail with respect to the alternate cover 50′ of FIGS. 5-7. The alternate cover 50′ has an upper perforation 56′ upon which an upper opening cover portion 70′ of the cover 50′ can be torn and separated from the second receptacle cover portion 72′. Alternatively, the cover 50′ can be torn along a central perforation 58′ to separate an upper cover portion 74′ from a lower cover portion 76′. Alternatively, the cover 50′ may be folded along the perforation lines 56′, 58′. Various portions of the cover 50′ can be either (1) torn away in order to separate and remove such portion of the cover 50′, so as to expose an opening, a portion of an opening or an opening and a portion of another opening and leave a remaining portion of the cover 50′ in a manner similar to that shown in FIGS. 10 and 11, or (2) folded in order to expose an opening, a portion of an opening or an opening and a portion of another opening and leave a remaining portion of the cover 50′ over an opening in a manner similar to that shown in FIGS. 15 and 16 where a further alternate cover 50″″ is folded along fold lines 56″″ and 58″″.

Referring now also to FIG. 12, a further cover 50″, the same as the cover 50′ shown in FIGS. 5-7 but having an upper cover portion 74″ having an air pass through area 80″ having air pass though openings 81″.

Referring now also to FIG. 13, a two-part alternate cover 50′″ is shown. Cover 50′″ includes a second compartment cover 50a′″, which is force fit into the second receptacle opening 36′ in a manner similar to the cover 50 shown in the cover 50 embodiment of FIGS. 1-4, and an upper surface adhesive cover 50b′″ having an adhesive 52′″ on a portion of the underside of the flexible cover 50b′″. The upper surface adhesive cover 50b′″ is preferably a peel-away cover.

Referring now also to FIGS. 14-16, a further cover 50″″ is illustrated in FIGS. 14-16. Cover 50″″ is generally the same as the cover 50′, shown in FIGS. 5-7, but cover 50″″ has fold lines 56″″ and 58″″ in the place of the perforation lines 56′ and 58′. Portions of the cover 50″″ can be folded on other portions of the cover 50″″ in order to expose the upper surface opening 40 in the manner shown in FIG. 15, or to expose a portion of the second receptacle opening 36 and the upper surface opening 40, as shown in FIG. 16.

The outer container 10 can also have other features such a “ribbed” side wall (not shown) also on the exterior surface 13 for increased grip or traction by the user (not shown).

The composition of the outer container 10 may be any of a variety of synthetic or a combination of synthetic and or natural products that are commonly used for food packaging and are suitable for this application. Preferably, however this material will be either a Styrofoam mix, or milk carton paper with a wax covering, preferably a standard paper cup such as the Sweetheart Gourmet Cup, Product No. 65596 X20N. The outer container 10 can be made of opaque/solid or translucent/clear materials. The outer container 10 is of various sizes, with volume capacities ranging from 4 fluid ounces to 64 fluid ounces, but may be of other sizes as well.

The upper opening 40 may be of various sizes (diameters) or shapes (circular, oval, rectangle, square), depending on the application desired. The distance between the inner edge 34 and the center of the upper surface opening 40 will generally not be more than about 1 inch and will preferably be about 1 inch or less, more preferably about 0.75 inches or less, even more preferably about 0.60 inches or less and most preferably about 0.5 inches or less. The inner container 20 can also include a vent hole 64, which may be of various sizes depending on application, and is generally located on the opposite side of the upper surface opening 40 primarily for visual balance or aesthetic reasons.

The inner wall 26 of the inner container 20 may be “fluted” with raised columns (vertical in the upright position) (not shown) to reduce surface contact with the contents of the inner container 20, thereby enhancing flow when the food container is inverted during use.

The adhesive sealing ring 48, shown in FIGS. 3 and 4, is helpful for pre-filling applications. The adhesive ring 48 is located between the rim grasping outer edge 32′ and the outer rim 16′. After the respective food items have been filled into the outer container 10′ and the inner container 20′, the rim grasping outer edge 32′ of the inner container 20′ is preferably engaged with the outer rim 16′ or the inner container 20′ can be engaged with the outer container 10′ when both are empty and each can be filled following such engagement. The adhesive ring 48 serves to create a permanent bond between the rim grasping outer edge 32′ and the outer rim 16′ for one-time use. The adhesive ring 48′ is preferably made of a wax, silicone, hot glue, or other standard sealant available for suitable use in food containers.

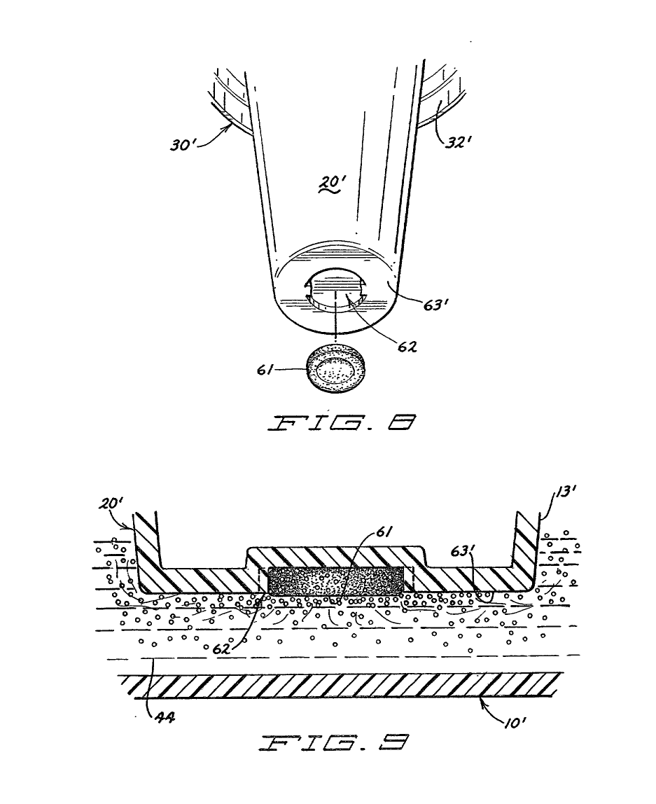

Referring now also to FIGS. 8 and 9, the preferred inner container 20′ shown in FIG. 3 will preferably have a recess 62 on the bottom 63′ of the container 20′ for receiving a flavor-enhancing tablet 61. The recess 62 is shaped and sized to receive a flavor-enhancing tablet. Such shape may be round or circular, for example. The recess 62 may range in size from about 10% to 90% of the bottom surface 63 of the inner container 20′. The depth of the bottom recess 62 may range from about one-eighth of an inch to about one inch. The flavor-enhancing tablet 61 is designed to dissolve in fluid food items that are aqueous or have an aqueous phase. The following list cites some examples of potential flavor ingredients in preferred flavor supplements, but is not meant to be an exhaustive list: sugar; spice; salt; pepper; soup flavor; broth flavor; chocolate syrup or powder, “fizzy” tablet to be mixed with water; dry juice powder to be mixed with water; Kool Aid drink powder to be mixed with water and the like.

The composition of the inner container 20 will preferably be thermoformed styrene, preferably the same as the material used to form the Sweetheart Gourmet Lid, Product No. LTGX12, however, it may also be made of any other materials suitable for this application. The inner container 20 may be made of opaque/solid or translucent/clear materials.

The portable food container 2 of the present invention permits separate retention of first and second food items. The portable food container 2 includes an outer container 10, including a first receptacle 12, at least partially defining a first compartment 13, the first receptacle having an outer rim 16 and a first receptacle opening 18 defined by the outer rim 16; an inner container 20 including a second receptacle 22 at least partially defining a second compartment 28, the second receptacle 22 having a peripheral collar 30 having an outer edge 34 and an inner edge 34, the outer edge 32 designed and constructed to engage the outer rim 16 of the first receptacle 22 such that the inner container 20 resides at least partially within the outer container 10. The inner edge 34 defines a second receptacle opening 36; the peripheral collar 30 has an upper surface 38 interconnecting the outer edge 32 with the inner edge 34; the upper surface 38 has an upper surface opening 40 which communicates with the first compartment 13 when the outer edge 32 of the inner container 20 is engaged with the outer rim 16 of the outer container 10; and the upper cover 50 is designed and constructed to engage the peripheral collar 30 in such a manner so as to retain a first or second food items placed within the second compartment 28 when the upper cover 50 is engaged with the peripheral collar 30 and the second receptacle 22 is turned upside down.

The optimal or desired sizes, shapes, and volumes of, and proportions between, the first and second compartments 13 and 28 will typically be determined by the desired use for the container. In preferred embodiments, the volume of the second compartment 28 is from about 50% to about 99%, preferably about 60% to about 95% of the total volume of the first and second compartments 13, 28 combined.

In further embodiments, a further preferred portable food container 2′ has a continuous adhesive seal 48 joining the peripheral collar 30′ to the outer rim 16′ of the outer container 10′. The outer rim 16′ will preferably have an annular perimeter. In yet other embodiments, where the second receptacle 22′ has an outer wall 24′ which at least partially defines the first compartment 13′ when the outer edge 32′ of the peripheral collar 30′ is engaged with the outer rim 16′ of the outer container 10′, the portable food container 2′ preferably has a flavor tablet 61 including flavoring agents; wherein the flavor tablet 61 dissolves, thereby releasing the flavoring agents, when the tablet 61 comes into contact with fluids within the first compartment 28. In yet other embodiments, the second receptacle opening 36 is preferably separated from the upper surface opening 40′ by a distance of less than about 1 inch, more preferably a distance of less than or equal about 0.75 inches, even more preferably a distance of less than or equal about 0.5 inches. The peripheral collar 30′ preferably includes an air vent opening 64.

Force Fit Cover

The force fit cover 50, illustrated in FIGS. 1 and 2, is preferably a single piece that provides for a friction fit sealing mechanism for the second receptacle opening 36, the upper surface opening 40, and, in certain embodiments (not shown) the vent hole 64 of the inner container 20. The force fit cover 50 incorporates an upper perforation 56 to allow for an upper opening cover portion 70 and a second receptacle cover portion 72. The upper opening cover portion 70 is secured within the upper surface opening 40 and the second receptacle cover portion 72 is secured within the second receptacle opening 36.

The force fit cover 50 can be entirely removed and separated from the inner container 20. When the user (not shown) wishes to open both the upper opening 40 and the second receptacle cover portion 72, the user grasps either the smaller force fit tab 78 or the larger force fit tab 79 and peels or lifts away the entire force fit cover 50.

The smaller force fit portion 70 can be independently opened and closed or separated and removed from the inner container 20. When the user (not shown) wishes to open the upper opening 40, the user grasps the small portion tab 78 and lifts the smaller force fit portion 70. The perforation 56 on the smaller force fit portion 70 acts as a living hinge. Thus, to re-seal the upper opening 40, the user pushes down on the smaller force fit portion 70 until it is re-engaged with the inner container 20. The user can also completely remove the smaller force fit portion 70 from the force fit cover 50 by tearing along the upper perforation 56.

The larger force fit portion 72 can be independently opened and closed or separated and removed from the inner container 20. The larger force fit portion 72, can be manipulated by a large portion tab 79 connected to the larger force fit portion 72. When the user (not shown) wishes to open the second receptacle opening 36, the user grasps the larger force fit tab 79 and lifts the larger force fit portion 72. The perforation 58 on the larger force fit portion acts as a living hinge. Thus, to re-seal the second receptacle opening 36, the user pushes down on the larger force fit portion 72 until it is re-engaged with the inner container 20. The user can also completely remove the larger force fit portion 72 from the force fit cover 50 by tearing along perforation 58.

The material used to make the force fit cover 50 is preferably thermoformed styrene, however, it may also be made of other materials suitable for this application. The force fit cover 50 may be made of opaque/solid or translucent/clear materials.

Adhesive Cover

The adhesive cover 50′, illustrated for example in FIGS. 5-7, has a topside 55′ and a bottom side 54′. The outer perimeter 51′ of bottom side 54′ is covered with an adhesive material 52 that permits the adhesive cover 50′ to be secured to the inner container 20 such that the second receptacle opening 36 and the upper opening 40 are closed to the outside when the cover 50′ is sealingly engaged with the peripheral collar 30. The adhesive material will adhere to the upper surface 38 between the inner edge 34 and the outer edge 32 of the inner container 20. The adhesive cover 50′ is preferably a single integral piece that provides a secure seal over the second receptacle opening 36 and the upper surface opening 40 and the vent hole 64.

The adhesive cover 50′ incorporates perforations 56′, 58′ to allow for the separation of a smaller portion 70 and a larger portion 72. The adhesive cover 50′ can be entirely removed and separated from the inner container 20. When the user (not shown) wishes to open both the upper opening 40 and the second receptacle opening 36, the user grasps either the smaller cover tab 78 or the larger cover tab 79 and peels or tears away the entire adhesive cover 50′.

The adhesive cover 50′ is preferably a thin metal foil, such as aluminum foil, or thin plastic sheeting, however, it may also be made of other materials suitable for this application. The adhesive cover 50′ may be of opaque/solid or translucent/clear materials.

As illustrated in FIG. 2, a vent opening 64 may be formed in the upper surface 38 to enable air flow into the first compartment 13 of the food container 2 to facilitate the flow of liquid through the drinking opening. A drain opening may be formed at the bottom of the recess to enable liquid to drain from the recess into the cup if this is deemed to be desirable.

The simple design of this product offers multiple market distribution options, such as:

retail sale for self-filling by the consumer with food products of their choice;

on-site filling by a foodservice retailer for sale to the consumer;

on-site filling by the consumer at a foodservice retailer either preceding or following sale to the consumer; and/or

pre-filling by a food processor, shipment to a retail site for sale to the consumer.

This product will accommodate a wide variety of food products. The following list cites some examples of solid and liquid foods, but is not meant to be an exhaustive list. Also, the following solid and liquid food items can be intermixed in any combination.

| Solid Food | Liquid Food |
|---|---|
| Dry or Ready-to-eat cereal | Milk |
| Bite sized crackers | Liquid yogurt; semi-liquid yogurt |
| Bite sized cookies | Soft drinks |
| Trail mix | Fruit juice/drinks; fruit purees |
| Nuts | Water |
| Raisins | Sports drinks |
| Popcorn | Soups; Nutrasoups |
| Candy | Coffee |
| Cut Fruit | Tea |
| Bite sized donuts | Cocoa |
| Natural Fruit (blueberries, | Liquid ice cream; semi-liquid ice cream |
| strawberries, etc.) | |
| Chocolates, fine candies | Energy Drinks |
| Pretzels; Bite sized bagels | Beer, wine, alcoholic drinks |

The present invention is generally embodied in a food container 2 including an outer container 10 having an outer rim 16 and an inner container 20 having a rim grasping outer edge 32, which is designed to easily force fit over the outer rim 16 of the outer container 10 to engage the inner container 20.

The outer container 10 is preferably made of a Styrofoam mix, preferably Sweetheart Gourmet Cup, Product No. 65596 X20N. The outer container 10 can have various sizes, preferably ranging in size from 4 to 64 fluid ounces, but may be of other sizes as well.

The inner container 20 is preferably made of a thermoformed polystyrene, preferably that used for a Sweetheart Gourmet Lid, Product No. LTGX12. The second compartment of the inner container 20 can also be of various sizes, preferably ranging in size from 2 to 60 fluid ounces, but may be modified to accommodate other volumes as well.

The present invention is generally embodied in a portable food container designed for consumer use. This product is designed for the storage, transport, and consumption of solid and liquid food combinations, though may be suitable for other applications as well. This device stores the solid and liquid foods in separate compartments for freshness (“a container within a container”). The solid and liquid foods are then delivered from the device on demand, either independently or simultaneously.

This device offers the consumer convenient, single-hand operation. The solid and liquid contents are extracted via gravity by inverting the unit from a stationary, upright position, and/or employing slight squeeze pressure to the outer container, and/or employing slight suction over the upper surface opening to increase flow of the liquid contents.

This product offers the ultimate in convenience and choice for the on-the-go consumer. For the first time, consumers can enjoy their favorite snack and drink anytime, anywhere, all from one, easy-to-use container.

The simple design of this product offers multiple market distribution options, such as:

### EXAMPLE 1

Retail sale for self-filling by the consumer with solid/liquid food products of their choice, for use at the time and locations of their choice (allows consumer with greatest food product choice and most economical). This example illustrates how a consuming family can purchase containers and each family member can put the containers to use to satisfy their differing desires.

For example, a mother of three children buys a package of food containers (say in a quantity of 50) at Target. On a typical school day, the oldest child fills her food container with Cheerios and 2% milk and enjoys her breakfast in her bedroom while getting ready for school. The two younger children fills their food containers with Corn Puffs and skim chocolate milk to be consumed on the bus ride to school. The father puts Grape Nuts and vanilla flavored liquid yogurt in his food container and takes it with him to work to eat in his office during the morning. Mom enjoys trail mix and apple juice in her food container on her drive to her office. After school and on the way to soccer practice, the two boys use the containers to contain and dispense a snack of raisins and Gatorade.

### EXAMPLE 2

On-site filling by a foodservice retailer for sale to the consumer (allows increased convenience to consumer and healthier solid/liquid food product options).

For example, while on the way to school in a carpool, a group of teenagers orders at the drive-up window of a McDonald's along the way. One teen orders Cheerios and 1% milk, and another orders bite-sized Oreo cookies and liquid ice cream. Optionally, McDonald's may also offer bulk “self serve” refill stations in-store for patrons to refill their food containers with milk, juices, soda, etc. with a small variety of cereals (similar to the existing “self serve” stations for soda refills).

For example, a person stops at Starbuck's on the weekend where he orders a favorite coffee drink, as well as, a food container filled with Cheerios and 1% milk.

For example, a person fills her food container with fruit and liquid yogurt at the corporate cafeteria at work and enjoys at her desk.

### EXAMPLE 3

Pre-filling by a food processor, shipment to a retail site for sale to the consumer (allows increased convenience to consumer and healthier solid/liquid food product options). Pre-filling by a food processor, shipment to a retail site for sale to the consumer (allows increased convenience to consumer and healthier solid/liquid food product options). Food processors have the option of reducing the individual size of their food products (i.e., “mini Cheerios”, smaller Life squares, smaller flakes, “mini pretzels”, etc.), to increase volume density; thus, they can reintroduce long established food brands as “new and improved” and market for specific use in this portable food container.

For example, a dry cereal producer offers pre-filled variety “4 packs” of dry cereal and 2% milk for sale at the refrigerated section of grocery stores. A parent buys the variety packs at the supermarket for the kids to “grab and go” while on their way to the park to play with their friends.

In another example, a dry cereal producer may also offer single serve food containers at convenience stores and kiosks. A traveler “grabs” one at the kiosk in the airport before catching her flight. The student buys one at the high school between her classes or after school.

### EXAMPLE 4

In yet another example, a dry cereal producer may also offer single serve food containers with only the dry food portion in a pre-sealed food container. The consumer would then add the liquid food of their choice via a flexible spout, which may be screwed onto the opening of a standard milk jug, which is placed in the upper surface opening of the food container for filing prior to consumption. This would allow food processors to offer the food container for sale at the dry goods section of grocery (cereal isle) and convenience stores, or case shipment directly to the consumers home.

While preferred embodiments of the present invention have been described above and illustrated in the accompanying drawings, there is no intent to limit the scope of the invention to this or any other particular embodiment.

What is claimed is:

1. A portable food container for separately retaining first and second food items, the portable food container comprising:
an outer container including a first receptacle at least partially defining a first compartment for retaining a food item selected from the group consisting of the first and second food items, the first receptacle having an outer rim and a first receptacle opening defined by the outer rim;
an inner container including a second receptacle at least partially defining a second compartment for retaining a food item selected from the group consisting of the first and second food items, the second receptacle having a peripheral collar having an outer edge and an inner edge, the outer edge designed and constructed to engage the outer rim of the first receptacle such that the inner container resides at least partially within the outer container; the inner edge defining a second receptacle opening; the peripheral collar having an upper surface interconnecting the outer edge with the inner edge; the upper surface having an upper surface opening which communicates with the first compartment when the outer edge of the peripheral collar is engaged with the outer rim of the outer container; and
an upper cover designed and constructed to engage the peripheral collar in such a manner so as to retain a first or second food item placed within the second compartment when the upper cover is engaged with the peripheral collar and the second receptacle is turned from a first position, where the second receptacle opening is positioned generally above the second compartment, to a second position, where the second receptacle opening is positioned generally below the second compartment and the force of gravity would otherwise cause any first or second food item within the second compartment to fall out of such second compartment.

2. The portable food container of claim 1, wherein the upper cover covers both the second receptacle opening and the upper surface opening.

3. The portable food container of claim 2, wherein the upper cover is force fit to engage both the second receptacle opening and the upper surface opening.

4. The portable food container of claim 2, wherein the upper cover includes an adhesive, which engages the upper cover to the peripheral collar.

5. The portable food container of claim 1, wherein the upper cover covers only the second receptacle opening and the upper surface opening is covered by a second cover smaller than the upper cover.

6. The portable food container of claim 1, wherein the outer rim has an annular perimeter.

7. The portable food container of claim 1, further comprising a continuous adhesive seal joining the peripheral collar to the outer rim of the outer container.

8. The portable food container of claim 1, wherein the second receptacle has an outer wall which at least partially defines the first compartment when the outer edge of the peripheral collar is engaged with the outer rim of the outer container; the portable food container having a flavor tablet including flavoring agents; wherein the flavor tablet is positioned within the first compartment such that the tablet dissolves, thereby releasing the flavoring agents, when the tablet comes into contact with a fluid food item within the first compartment having an aqueous phase.

9. The portable food container of claim 8, wherein the flavor tablet is engaged with the outer wall of the second receptacle.

10. The portable food container of claim 9, wherein the outer wall of the second receptacle has a bottom surface, the bottom surface having a recess, the flavor tablet being engaged with the outer wall within the recess.

11. The portable food container of claim 1, wherein the second receptacle has an outer wall which at least partially defines the first compartment when the outer edge of the peripheral collar is engaged with the outer rim of the outer container and the second receptacle has an inner wall which at least partially defines the second compartment; the first compartment having a first volume and the second compartment having a second volume, the second volume being equal to or greater than the first volume.

12. The portable food container of claim 1, wherein the second receptacle has an outer wall which at least partially defines the first compartment when the outer edge of the peripheral collar is engaged with the outer rim of the outer container and the second receptacle has an inner wall which at least partially defines the second compartment; the first compartment having a first volume and the second compartment having a second volume, wherein the second volume is from about 50% to about 99% of the total volume of the first volume and the second volume combined.

13. The portable food container of claim 1, wherein the second receptacle opening is separated from the upper surface opening by a distance of less than about 1 inch.

14. The portable food container of claim 1, wherein the peripheral collar further includes an air vent opening.

15. A portable food container for separately retaining first and second food items, the portable food container comprising:
an outer container including a first receptacle at least partially defining a first compartment for retaining a food item selected from the group consisting of the first and second food items, the first receptacle having an outer rim and a first receptacle opening defined by the outer rim;
an inner container including a second receptacle at least partially defining a second compartment for retaining a food item selected from the group consisting of the first and second food items, the second receptacle having a peripheral collar having an outer edge and an inner edge, the outer edge designed and constructed to engage the outer rim of the first receptacle such that the inner container resides at least partially within the outer container; the inner edge defining a second receptacle opening; the peripheral collar having an upper surface interconnecting the outer edge with the inner edge; the upper surface having an upper surface opening which communicates with the first compartment when the outer edge of the inner container is engaged with the outer rim of the outer container; and
an upper cover designed and constructed to engage the peripheral collar in such a manner so as to retain a first or second food item placed within the second compartment when the upper cover is engaged with the peripheral collar and the second receptacle is turned from a first position, where the second receptacle opening is positioned generally above the second compartment, to a second position, where the second receptacle opening is positioned generally below the second compartment and the force of gravity would otherwise cause any first or second food item within the second compartment to fall out of such second compartment; wherein the second receptacle has an outer wall which at least partially defines the first compartment when the outer edge of the peripheral collar is engaged with the outer rim of the outer container and the second receptacle has an inner wall which at least partially defines the second compartment; the first compartment having a first volume and the second compartment having a second volume, wherein the second volume is from about 50% to about 99% of the total volume of the first volume and the second volume combined.

16. The portable food container of claim 15, further comprising a continuous adhesive seal joining the peripheral collar to the outer rim of the outer container, wherein the outer rim has an annular perimeter.

17. The portable food container of claim 15, wherein the second receptacle has an outer wall which at least partially defines the first compartment when the outer edge of the peripheral collar is engaged with the outer rim of the outer container; the portable food container having a flavor tablet including flavoring agents; wherein the flavor tablet dissolves, thereby releasing the flavoring agents, when the tablet comes into contact with fluids within the first compartment having an aqueous phase; the flavoring agent being engaged with the outer wall such that it will come into contact with fluid if a fluid food item is filled into the first compartment.

18. The portable food container of claim 17, wherein the outer wall of the second receptacle has a bottom surface, the bottom surface having a recess, the flavor tablet being engaged with the outer wall within the recess.

19. The portable food container of claim 15, wherein the second receptacle opening is separated from the upper surface opening by a distance of less than about 1 inch.

20. The portable food container of claim 15, wherein the peripheral collar further includes an air vent opening.

21. A portable food container for separately retaining first and second food items, the portable food container comprising:
an outer container including a first receptacle at least partially defining a first compartment for retaining a food item selected from the group consisting of the first and second food items, the first receptacle having an outer rim and a first receptacle opening defined by the outer rim;
an inner container including a second receptacle at least partially defining a second compartment for retaining a food item selected from the group consisting of the first and second food items, the second receptacle having a peripheral collar having an outer edge and an inner edge, the outer edge designed and constructed to engage the outer rim of the first receptacle such that the inner container resides at least partially within the outer container; the inner edge defining a second receptacle opening; the peripheral collar having an upper surface interconnecting the outer edge with the inner edge; the upper surface having an upper surface opening which communicates with the first compartment when the outer edge of the inner container is engaged with the outer rim of the outer container; and
an upper cover designed and constructed to engage the peripheral collar in such a manner so as to retain a first or second food item placed within the second compartment when the upper cover is engaged with the peripheral collar and the second receptacle is turned from a first position, where the second receptacle opening is positioned generally above the second compartment, to a second position, where the second receptacle opening is positioned generally below the second compartment and the force of gravity would otherwise cause any first or second food item within the second compartment to fall out of such second compartment; wherein the second receptacle has an outer wall which at least partially defines the first compartment when the outer edge of the peripheral collar is engaged with the outer rim of the outer container and the second receptacle has an inner wall which at least partially defines the second compartment; wherein the second receptacle opening is separated from the upper surface opening by a distance of less than about 1 inch.

22. The portable food container of claim 21, further comprising a continuous adhesive seal joining the peripheral collar to the outer rim of the outer container, wherein the outer rim has an annular perimeter.

23. The portable food container of claim 21, wherein the second receptacle has an outer wall which at least partially defines the first compartment when the outer edge of the peripheral collar is engaged with the outer rim of the outer container and the second receptacle has an inner wall which at least partially defines the second compartment; the first compartment having a first volume and the second compartment having a second volume, wherein the second volume is from about 50% to about 99% of the total volume of the first volume and the second volume combined.

24. The portable food container of claim 21, wherein the second receptacle has an outer wall which at least partially defines the first compartment when the outer edge of the peripheral collar is engaged with the outer rim of the outer container; the portable food container having a flavor tablet including flavoring agents; wherein the flavor tablet is positioned within the first compartment such that the tablet dissolves, thereby releasing the flavoring agents, when the tablet comes into contact with a fluid food item within the first compartment having an aqueous phase.

25. The portable food container of claim 24, wherein the flavor tablet is engaged with the outer wall of the second receptacle.

26. The portable food container of claim 25, wherein the outer wall of the second receptacle has a bottom surface, the bottom surface having a recess, the flavor tablet being engaged with the outer wall within the recess.

27. The portable food container of claim 21, wherein the peripheral collar further includes an air vent opening.
